(19) United States
(12) Patent Application Publication
(10) Pub. No.: US 2011/0273047 A1
(43) Pub. Date: Nov. 10, 2011

(54) ROTOR LAMINATION ASSEMBLY

(75) Inventors: Balazs Palfai, Fishers, IN (US); Bradley D. Chamberlin, Pendleton, IN (US); David A. Fulton, Anderson, IN (US); Rui Guan, Pendleton, IN (US)

(73) Assignee: REMY TECHNOLOGIES, L.L.C., Pendleton, IN (US)

(21) Appl. No.: 12/776,988

(22) Filed: May 10, 2010

(51) Int. Cl. H02K 1/27; H02K 15/03

(52) U.S. Cl. 310/156.01; 29/598

(57) ABSTRACT

An electric machine includes a stator, and a rotor lamination assembly configured to rotate relative to the stator. The rotor assembly includes at least one lamination member that includes a body having an inner diametric edge that extends to an outer diametric edge, and at least one magnet receiving member. The at least one magnet receiving member is formed in the body and includes a first end that extends to a second end. The second end is spaced from the outer diametric edge to form a bridge portion. The at least one lamination member includes at least one stress concentration element positioned between the inner diametric edge and the outer diametric edge. The at least one stress concentration element is configured and disposed to reduce stress in the bridge portion.

### BACKGROUND OF THE INVENTION

The subject matter disclosed herein relates to the art of electric machines and, more particularly, to a rotor lamination assembly for a permanent magnet electric machine.

Electric machines include a rotor that sets up a magnetic field. Electrical current passing though a stator is influenced by the magnetic field creating an electro-motive force that causes the rotor to spin. Certain electric motors/generators employ permanent magnets in the rotor. The permanent magnets are mounted in magnet slots formed in the rotor, which is typically formed from a plurality of laminations. Generally, the permanent magnets are mounted near an outside edge of the rotor, as close to the outside edge as possible, in order to maximize torque and minimize losses. Mounting the permanent magnets in this manner creates a thin bridge area between the magnet slots and the outside edge of the rotor.

During high speed operation, centrifugal forces on the rotor create stress in the thin bridge area. If operated at too high a speed, the stress can exceed the yield strength of the laminations. In such a case, the rotor could fail. Accordingly, there is a trade off between maximizing torque and high speed operation. That is, maximizing torque by mounting the permanent magnets as close to the outside edge of the rotor limits the operational speed of the electrical machine.

### BRIEF DESCRIPTION OF THE INVENTION

According to one aspect of the invention, an electric machine includes a stator, and a rotor lamination assembly configured and disposed to rotate relative to the stator. The rotor assembly includes at least one lamination members that includes a body having an inner diametric edge that extends to an outer diametric edge, and at least one magnet receiving member. The at least one magnet receiving member is formed in the body and includes a first end that extends to a second end. The second end is spaced from the outer diametric edge to form a bridge portion. The at least one lamination member includes at least one stress concentration element positioned between the inner diametric edge and the outer diametric edge. The at least one stress concentration element is configured and disposed to reduce stress in the bridge portion.

According to another aspect of the invention, a method of forming a high speed rotor lamination member includes forming a lamination member that includes a body having an inner diametric edge that extends to an outer diametric edge. At least one magnet receiving member is created in the body. The at least one magnet receiving member includes a first end that extends to a second end. The second end is spaced from the outer diametric edge to form a bridge portion. At least one stress concentration element is constructed in the lamination member. The at least one stress concentration member is arranged between the inner diametric edge and the outer diametric edge. The at least one stress concentration element is configured and disposed to reduce stress in the bridge portion.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a cross-sectional side view of an electric machine including a rotor lamination assembly in accordance with an exemplary embodiment;

FIG. 2 is a plan view of a lamination member of the rotor lamination assembly of FIG. 1;

FIG. 3 is a detail view of a magnet receiving member and a portion of an adjacent stress concentration element of the lamination member of FIG. 2; and

FIG. 4 is a plan view of a lamination member in accordance with another aspect of the exemplary embodiment.

The detailed description explains embodiments of the invention, together with advantages and features, by way of example with reference to the drawings.

### DETAILED DESCRIPTION OF THE INVENTION

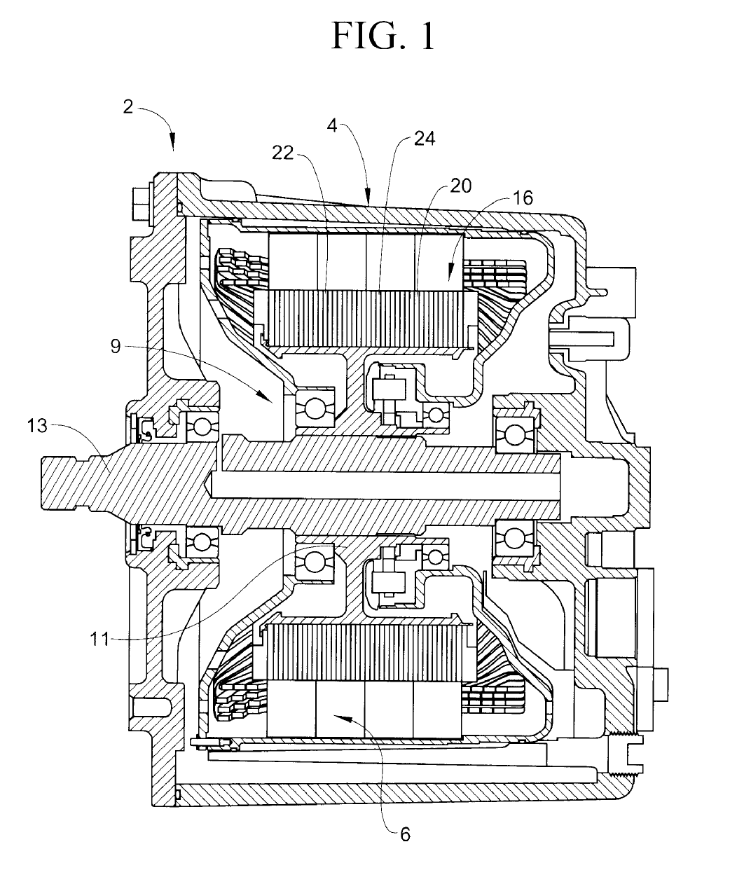

Referring to FIG. 1, an electric machine constructed in accordance with an exemplary embodiment is indicated generally at 2. Electric machine 2 includes a housing 4 having mounted thereto a stator 6. A rotor assembly 9 rotates relative to stator 6 to produce an electro-motive force. In the exemplary embodiment shown, rotor assembly 9 includes a hub portion 11 having mounted thereto a shaft 13. Rotor assembly 9 also includes a rotor lamination assembly 16 formed from a plurality of lamination members, one of which is indicated at 20.

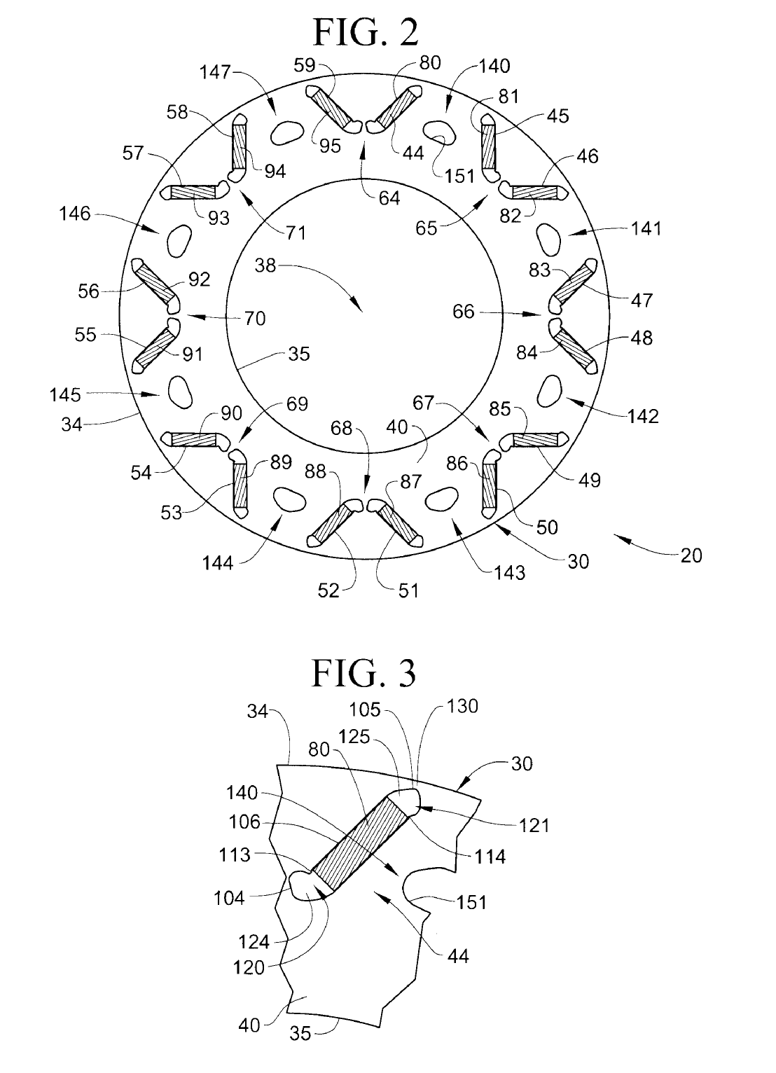

Reference will now be made to FIG. 2 in describing lamination member 20 in accordance with an exemplary embodiment. Lamination member 20 includes a body 30 having an outer diametric edge 34, and an inner diametric edge 35 that defines a rotor hub receiving portion 38. Outer diametric edge 34 is spaced from inner diametric edge 35 through a web portion 40. As shown, lamination member 20 includes a plurality of magnet receiving members 44-59 arranged about outer diametric edge 34. More specifically, magnet receiving members 44-59 are arranged in pairs 64-71 spaced annularly about outer diametric edge 34. Each magnet receiving member 44-59 is configured and disposed to accept a corresponding one of a plurality of magnets 80-95.

As each magnet receiving member is similarly formed, a detailed description will follow with reference to FIG. 3 in describing magnet receiving member 44 with an understanding that the remaining magnet receiving members 45-59 include similar structure. Magnet receiving member 44 includes a first end 104 that extends to a second end 105 through an intermediate portion 106. Magnet receiving member 44 includes a first magnet retaining member 113 arranged proximate to first end 104 and a second magnet retaining member 114 arranged proximate to second end 105. First and second magnet retaining members 113 and 114 are configured to position magnet 80 within magnet receiving member 44. As shown, a first void 120 is established between first end 104 and magnet 80, and a second void is established between second end 105 and magnet 80. Each void 120 and 121 is provided with a corresponding filler material 124 and 125. In accordance with an aspect of the exemplary embodiment, filler 124 and 125 is formed from injected plastic that not only holds magnet 80 in magnet receiving member 44 but, when combined with other lamination members, also prevents oil from entering into lamination assembly 16.

Second end 105 of magnet receiving member 44 is spaced from outer diametric edge 34 forming a bridge portion 130. Bridge portion 130 is typically formed to be as thin as possible so as to reduce magnetic flux losses from lamination assembly 16. However, the thickness of bridge portion 130 places limits on an overall operational speed envelope of electric machine 2. More specifically, if bridge portion 130 is formed to be so thin as to reduce most if not all loses; electric machine 2 cannot be operated at speeds above, for example 5,000 rpm. When operated at such speeds, centrifugal forces on rotor lamination assembly 16 create stress in bridge portion 130. If the stress bridge portion 130 exceeds a yield strength of body 30, lamination member 20 could fail. In order to mitigate the stress in bridge portion 130, and enable electric machine to operate at speeds above 5000 rpm, lamination member 20 includes a plurality of stress concentration elements 140-147 arrayed about web portion 40.

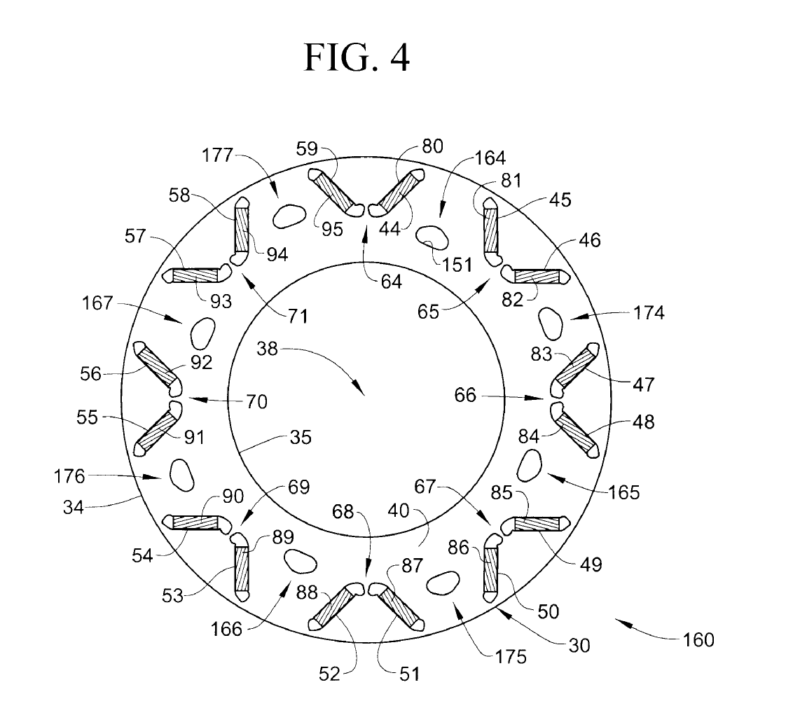

Stress concentration elements 140-147 are positioned between adjacent ones of pairs 64-71 and include a continuous edge, such as shown at 151 on stress concentration element 140 that defines an opening in web portion 40. In the exemplary embodiment shown, continuous edge 151 defines an irregular, i.e., non-circular opening. However, it should be understood that continuous edge 151 could also define a circular opening. Stress concentration elements 140-147 extends about web portion 40 along a radial axis. However, it should also be understood that in accordance with other aspects of the exemplary embodiment, stress concentration elements can be staggered over web portion 40. For example, in FIG. 4 wherein like reference numbers represent corresponding parts in the respective views, a lamination member 160 in accordance with another aspect of the exemplary embodiment includes a first plurality of stress concentration elements 164-167 arrayed about web portion 40 along a first radial axis and a second plurality of stress concentration elements 174-177 arrayed about web portion 40 along a second radial axis.

During high speed operation, stresses resulting from centrifugal force on lamination member 20, shift away from bridge portion 130 and toward stress concentration elements 140-147. In this manner, electric machine 2 can be operated at high speeds without experiencing stress cracking at the bridge portions, or magnetic flux losses at the outer edge. At this point it should be understood that the particular number, size, disposition, and shape of the stress concentration elements could vary without departing from the scope of the claims. Also, it should be understood that exemplary embodiments do not require that all lamination members include stress concentration elements.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An electric machine comprising:
a stator; and
a rotor lamination assembly configured and disposed to rotate relative to the stator; the rotor lamination assembly comprising:
at least one lamination including a body having an inner diametric edge that extends to an outer diametric edge, and at least one magnet receiving member, the at least one magnet receiving member being formed in the body and including a first end that extends to a second end, the second end being spaced from the outer diametric edge to form a bridge portion, the at least one lamination member including at least one stress concentration element positioned between the inner diametric edge and the outer diametric edge, the at least one stress concentration element being configured and disposed to reduce stress in the bridge portion.

2. The electric machine according to claim 1, wherein the at least one stress concentration element includes a continuous edge that defines an opening in the body.

3. The electric machine according to claim 1, wherein the at least one magnet receiving member comprises a plurality of magnet receiving members arranged in pairs about the outer diametric edge, the at least one stress concentration element being arranged between adjacent pairs of the plurality of magnet receiving members.

4. The electric machine according to claim 3, wherein the at least one stress concentration element comprises a plurality of stress concentration elements, each of the plurality of stress concentration elements being arranged between corresponding ones of the adjacent pairs of the magnet receiving members.

5. The electric machine according to claim 2, wherein the at least one stress concentration element comprises a first plurality of stress concentration members arranged along a first radial axis of the body member and a second plurality of stress concentration members arranged along a second radial axis of the body member, the second radial axis being off-set from the first radial axis.

6. The electric machine according to claim 2, wherein the continuous edge includes a non-circular profile.

7. A method of forming a high speed rotor lamination member, the method comprising:
forming a lamination member including a body having an inner diametric edge that extends to an outer diametric edge;
creating at least one magnet receiving member in the body, the at least one magnet receiving member including a first end that extends to a second end, the second end being spaced from the outer diametric edge to form a bridge portion; and
constructing at least one stress concentration element in the lamination member, the at least one stress concentration member being arranged between the inner diametric edge and the at least one magnet receiving member, the at least one stress concentration element being configured and disposed to reduce stress in the bridge portion.

8. The method of claim 7, wherein creating at least one magnet receiving member includes forming a plurality of magnet receiving members in the body member about the outer diametric edge.

9. The method of claim 8, further comprising: arranging the plurality of magnet receiving members in pairs along the outer diametric edge, the at least one stress concentration element being arranged between adjacent ones of the pairs of magnet receiving members.

10. The method of claim 7, wherein constructing the at least one stress concentration element comprises forming an opening in the body member.

11. The method of claim 10, wherein forming the opening in the body member comprises creating a non-circular opening in the body member.

12. The method of claim 7, wherein constructing the at least one stress concentration element comprises:
forming a first plurality of stress concentration elements along a first radial axis of the body member; and
creating a second plurality of stress concentration elements along a second radial axis of the body member, the second radial axis being off-set from the first radial axis.

13. The method of claim 7, further comprising: combining a plurality of lamination members to form a high speed rotor lamination assembly.
